(19) United States
(12) Patent Application Publication
(10) Pub. No.: US 2005/0086424 A1
(43) Pub. Date: Apr. 21, 2005

(54) Well-matched echo clock in memory system

(75) Inventors: Jong-Hoon Oh, Chapel Hill, NC (US); Jean-Marc Dortu, Munich (DE)

Correspondence Address: Dicke, Billig & Czaja, PLLC;Suite 2250, Fifth Street Towers, 100 South Fifth Street, Minneapolis, MN, 55402, US

(73) Assignees: Infineon Technologies North America Corp.; Infineon Technologies AG

(21) Appl. No.: 10/689,954

(22) Filed: Oct. 21, 2003

(51) Int. Cl. G06F 12/00

(52) U.S. Cl. 711/105

(57) ABSTRACT

The present invention is a random access memory device with a well-matched echo clock signal. The dynamic memory storage device includes a controller, a data bus and multiple memory modules. The data bus is coupled to the controller such that data read and data write information is transferred to and from the controller over the data bus. Multiple memory modules are coupled to the data bus and to the controller. Each of the memory module have a driver that produces an echo clock signal on an echo clock pin. The echo clock pin of each memory module is tied to each of the other memory modules and to the controller. In this way, during a read operation of the random access memory device the data bus and echo clock have matched loading conditions.

### BACKGROUND

This invention relates to dynamic memories and more particularly to multiple memory chips, each using an echo clock, which are placed on a single data bus.

In many memory systems, such as synchronized dynamic random access memory (SDRAM) or double data rate synchronized dynamic random access memories (DDR SDRAM) multiple load or parallel load configurations are common. In such a configuration, multiple memory modules are used and a controller poles the various memory modules to write information to and read information from the proper memory module.

In some applications, it is desirable to design the memory system to operate at extremely high clock frequencies. In these situations, it is common to configure the system as “point-to-point” connection between memory modules and the controller. In this situation, one memory module is placed on the data bus for a particular range. However, these high speed memory systems have limitations and use due to a single memory module placed on the data bus. An improvement to a high clock frequency system in the form of additional system capacity would be a useful addition to the art.

### SUMMARY

The present invention is a random access memory device with a well-matched echo clock signal. The dynamic memory storage device includes a controller, a data bus and multiple memory modules. The data bus is coupled to the controller such that data read and data write information is transferred to and from the controller over the data bus. Multiple memory modules are coupled to the data bus and to the controller. Each of the memory module have a driver that produces an echo clock signal on an echo clock pin. The echo clock pin of each memory module is tied to each of the other memory modules and to the controller. In this way, during a read operation of the random access memory device the data bus and echo clock have matched loading conditions.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a prior art dynamic memory system.

FIG. 2 illustrates timing signals for a system memory.

FIG. 3 illustrates a functional depiction of a system memory.

FIG. 4 illustrates a functional depiction of a system memory in accordance with the present invention.

FIG. 5 illustrates a functional depiction of an alternative system memory in accordance with the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

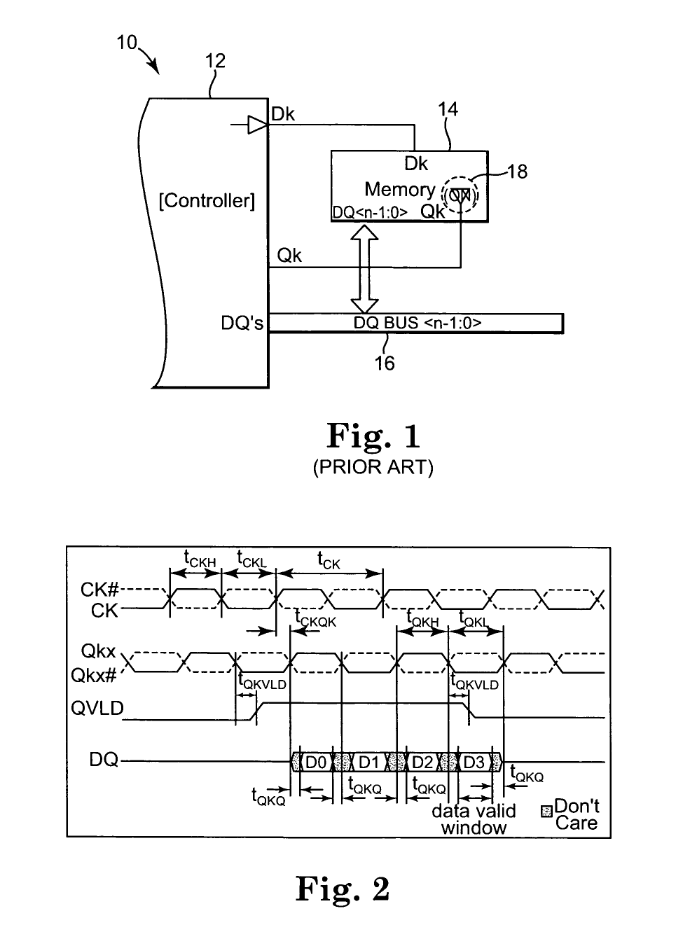

FIG. 1 illustrates a prior art memory system 10. Memory system 10 includes controller 12, memory module 14, and DQ data bus 16. Memory module 14 further includes on-chip driver 18. Memory module 14 is coupled to DQ bus 16 via DQ pins on memory module 14.

Memory system 10 is a point-to-point configured memory system wherein there is always one transmitter and one receiver in the communication system. During write cycle operation, controller 12 is transmitting data to, and receiving data from, memory module 14. Likewise, during read cycle operation data read from memory module 14 goes to single receiver, which is controller 12. This communication occurs through DQ data bus 16, such that there is always one transmitter and one receiver. During the write cycle, controller 12 produces clock signal Dk, which is a free-running echo clock for data input to memory 14. The Dk clock signal is received by memory 14. During the read cycle, driver 18 on memory module 14 produces a clock signal Qk, which is a free-running echo clock for data output from memory module 14. Qk clock signal is received by controller 12. In operation, the free-running echo clock Qk helps memory module 14 operate a very high data rate by allowing more accurate, real-time like timing adjustment and impedance matching. Since memory system 10 is designed to operate at such a high clock frequency, it must typically be configured as a point-to-point connection between memory module 14 and controller 12.

FIG. 2 illustrates timing in a random access memory device, such as memory system 10. A clock signal Ck (not shown in FIG. 1) is generated by controller 12 and is the common clock source for all commands in the operation of memory module 14. Ck and Ck# are differential clock signals. The CK and CK# clock signals have a clock cycle time t_{Ck} with a high time t_{CkH} and a low time t_{CkL}. Ck# is ideally 180 degrees out of phase with Ck. Qk and Qk# are the free-running echo clock signal generated by driver 18 in memory module 14 and is used for data output. Qk and Qk# clock signals also have a high time t_{QkH} and a low time t_{QkL}. Qk# is ideally 180 degrees out of phase with Qk. Qk and Qk# clock signals are skewed relative to the Ck and Ck# signals such that there is an edge-to-edge time difference t_{CkQk} between Ck and Qk signals. When memory system 10 is in a read cycle, a data valid (QVLD) signal indicates that valid output data is available. The time difference between the edge of the Qk signal and the QVLD signal is t_{QkVLD}. During read cycle, Qk and Qk# are transmitted by memory module 14 and edge-aligned with the data.

As is illustrated in FIG. 2, the Qk and Qk# signals must be well-matched to the loading of DQ data bus 16 for a proper read cycle. This matching assures a proper data read and avoids system error. For the Qk and Qk# signals to be well-matched to DQ data bus 16, the arrival time and waveform of the signals at the same point of controller 12 has to be the same between signal lines. These characteristics, arrival time and signal waveform, depend on the trace, that is, the physical wire from one point to another, on capacitive loading, that is, how many devices are connected to the signal lines, as well as other factors. Thus, in a point-to-point configuration, such as memory system 10, all the signals are well-matched since each transmitter has only one receiver. Thus, since the Qk and Qk# signals are coupled only to controller 12 and DQ data bus 16 is similarly only coupled to controller 12, the signals are well-matched.

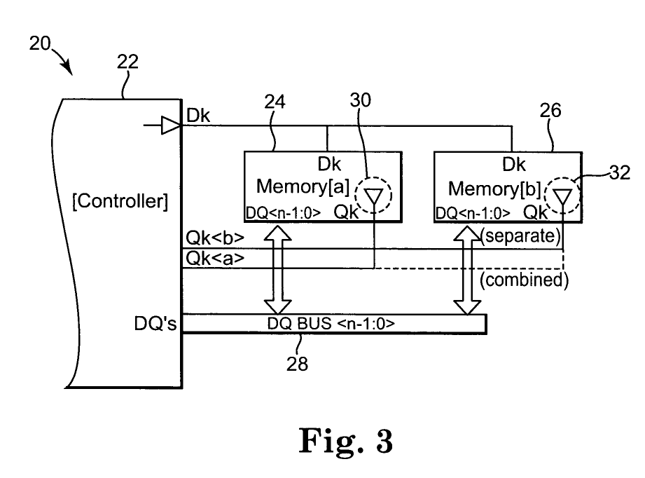

FIG. 3 illustrates a random access memory device, such as memory system 20 in accordance with the present invention. Memory system 20 includes controller 22, memory module (a) 24, memory module (b) 26, and DQ data bus 28. Controller 22 generates clock signal Dk which is a free-running echo clock for data input. The Dk clock signal is received by memory module (a) 24 and memory module (b) 26. Memory module (a) 24 and memory module (b) 26 are each coupled to controller 22 via DQ data bus 28 at DQ pins on memory modules 24 and 26. Memory module (a) 24 includes on-chip driver 30, which produces clock signal Qk(a). Clock signal Qk(a) is a free-running echo clock used for data output. Similarly, memory module (b) 26 includes on-chip driver 32, which produces clock signal Qk(b). Clock signal Qk(b) is also a free-running echo clock signal used for data output.

Memory system 20 is similar to the prior art memory system 10, except memory system 20 has two memory modules, memory module (a) 24 and memory module (b) 26, on the single data bus, DQ data bus 28. Although placing and additional memory modules on DQ data bus 28 increases memory capacity of memory system 20, placing the two memory modules on a single data bus creates problems for a high frequency system utilizing echo clocks on data output. Qk(a) and Qk(b) clock signals are free-running clocks such that they cannot be effectively tied together. This creates matching problems in memory system 20 that are not easily overcome.

In memory system 20, clock signal Dk is well-matched to DQ data bus 28 in terms of loading, because the Dk clock signal is connected to the controller 22 and to two memory modules, memory module (a) 24 and memory module (b) 26. DQ bus 28 has the same connections, that is, to the controller 22 and to two memory devices, memory module (a) 24 and memory module (b) 26. Thus, controller 22 always transmits the Dk clock signal to two receivers (memory module (a) 24 and memory module (b) 26) for the write cycle. If memory (b) 26 responds to the write operation, the Dk signal from controller 12 passes memory module (a) 24 and gets to memory module (b) 26. Similarly, write data on DQ bus 28 follows the same route as the Dk signal. During the write cycle to memory module (b) 26, data transmitted from controller 12 passes memory (a) 24 and gets to memory module (b) 26. Thus, the Dk signal and DQ data bus 28 are well-matched.

On the other hand, the Qk signals cannot be matched to DQ data bus 28 in system memory 20. The Qk signals are driven independently by each memory module 24 and 26 and cannot be tied together because they are free-running. For a read operation from memory module (b) 26, the Qk(b) clock signal goes directly to controller 22 without being tied to memory module (a) 26, while the read data on DQ bus 28 from memory module (b) 26 goes to controller 22 and also to memory module (a) 24. Thus, the capacitance or loading on the Qk signal and DQ bus 28 is not matched, because DQ bus 28 is coupled to two memory module (24 and 26) and controller 22, while the Qk(b) signal is coupled only to one memory module (26) and controller 22. Thus, matching is not attained. Whether the Qk(a) and Qk(b) signals are kept as separate lines or tied together as a common Qk line, neither situation can match the loading condition of the Qk signals to data bus 28. This will cause timing skew resulting in improper operation of such a system.

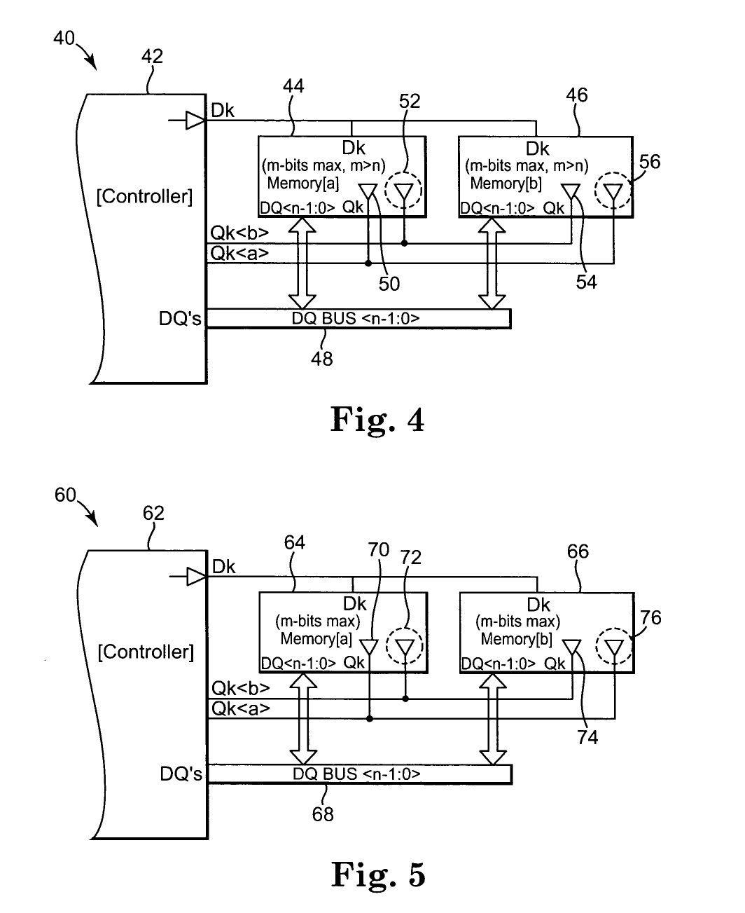

FIG. 4 illustrates memory system 40 in accordance with the present invention. Memory system 40 includes controller 42, memory module (a) 44, memory module (b) 46, and DQ data bus 48. Controller 42 generates a clock signal Dk, which is a free-running echo clock for data input. The Dk clock signal is received by memory module (a) 44 and memory module (b) 46. Memory module (a) 44 and memory module (b) 46 are coupled to controller 42 via DQ bus 48 at DQ pins on memory modules 44 and 46. Memory module (a) 44 includes on-chip driver 50 and buffer 52. Driver 50 generates a Qk(a) signal at Qk(a) pin on memory module 44. The Qk(a) signal is a free-running echo clock for data output. Similarly, memory module (b) 46 includes on-chip driver 54 and buffer 56. Driver 54 generates a Qk(b) signal at Qk(b) pin on memory module 46. The Qk(b) signal is a free-running echo clock for data output. The Qk(a) and Qk(b) signals are received by controller 42. Also, the Qk(a) signal is fed into buffer 56 of memory module (b) 46. Similarly, the Qk(b) signal is fed into buffer 52 of memory module (a) 44.

Both memory modules (a) 44 and (b) 46 are configured such that they are not using their maximum capacity. For example, memory module (a) 44 may be a ×32 memory configured to be used as a ×16 memory. In this way, memory module (a) 44 will have unused data buffer 52. Like memory module (a) 44, memory module (b) 46 includes buffer 56, which is an unused buffer due to memory module (b) 46 using less than its total maximum capacity.

Memory system 40 is configured to have multiple memory module on a single data bus and to utilize free-running echo clocks, and yet not have timing skew or improper operation. In operation of memory system 40, when memory module (a) 44 responds to a read command, Qk(a) is the strobe signal for DQ data bus 48 as a timing signal. Since data bus 48 is driven by memory module (a) 44 during this read operation, the DQ pins from memory module (b) 46 are a load (memory module (b) 46 is turned off at this time). Thus, in order for the signals to be well-matched, the Qk(a) signal must track the data bus 48 loading due to memory module (b) 46 being connected to DQ data bus 48. This is accomplished by having the Qk(a) signal feed into buffer 56 of memory module (b) 46. Since buffer 56 is unused it is always turned off and Qk(a) will see a load. In this way, both the Qk(a) signal and DQ data bus 48 have loading due to memory module (b) 46 and are thus well-matched.

With the improved configuration of system memory 40, loading of the echo clock signals Qk and loading of the data bus DQ is well matched. When memory system 40 is completing a read operation from memory module (b) 46, memory (b) 46 is driving DQ bus 48. Since memory module (b) 46 is being read, the DQ pins of memory module (a) 44 are loading. The Qk(b) signal from memory module (b) 46 goes into buffer 52 of memory module (a) 44 at this same time, thereby matching the loading conditions of DQ bus 48 and of the Qk(b) signal. This eliminates error associated with prior systems and achieves good timing in memory system 40.

FIG. 5 illustrates memory system 60 in accordance with the present invention. Memory system 60 includes controller 62, memory module (a) 64, memory module (b) 66, and DQ data bus 68. Controller 62 generates a clock signal Dk, which is a free-running echo clock for data input. The Dk clock signal is received by memory module (a) 64 and memory module (b) 66. Memory module (a) 64 and memory module (b) 66 are coupled to controller 62 via DQ bus 68 at DQ pins on memories 64 and 66. Memory module (a) 64 includes on-chip driver 70 and buffer 72. Driver 70 generates a Qk(a) signal at Qk(a) pin on memory module 64. The Qk(a) signal is a free-running echo clock for data output. Similarly, memory module (b) 66 includes on-chip driver 74 and buffer 76. Driver 74 generates a Qk(b) signal at Qk(b) pin on memory module 66. The Qk(b) signal is a free-running echo clock for data output. The Qk(a) and Qk(b) signals are received by controller 62. Also, the Qk(a) signal is fed into buffer 76 of memory (b) 76. Similarly, the Qk(b) signal is fed into buffer 72 of memory module (a) 64.

Memory system 60 is similar to memory system 40 described above, except that memory module (a) 64 and memory module (b) 66 are fully utilized, leaving no unused buffers. In this case, dummy buffers 72 and 76 are added to memory module (a) 64 and memory module (b) 66, respectively. Dummy buffers 72 and 76 can be wired and located on the memory package as dummy pins to work as matching load when such memory is used in a parallel load bus. Thus, memory system 60 operates very similarly to memory system 40, once dummy buffers 72 and 76 are added. In other words, system 60 is configured to have multiple memories on a single data bus and to utilize free-running echo clocks, and yet not have timing skew or improper operation.

When memory system 60 responds to a read command for memory module (a) 64, Qk(a) is the strobe signal for DQ data bus 68 as a timing signal. Since data bus 68 is driven by memory module (a) 64 during this read operation, the DQ pins from memory module (b) 66 are a load (memory module (b) 66 is turned off at this time). Thus, in order for the signals to be well-matched, the Qk(a) signal must track the data bus 68 loading due to memory module (b) 66 being connected to DQ data bus 68. This is accomplished by having the Qk(a) signal feed into dummy buffer 76 of memory module (b) 66. Since dummy buffer 76 is always off, it is a load to the Qk(a) signal. In this way, both the Qk(a) signal and DQ data bus 68 have loading due to memory module (b) 66 and are thus well-matched.

One skilled in the art will recognize that additional memory modules more than the two illustrated in FIGS. 4 and 5 may be added to the data bus, while still achieving the objects of the invention. Each additional memory module added to the data bus will have a driver producing an echo clock signal and a buffer—either an unused buffer or dummy buffer. If the echo clock signal of each memory module is tied to the buffer of each of the other memory modules, then the loading of the data bus will be matched to the echo clock during the read operation.

Although specific embodiments have been illustrated and described herein, it will be appreciated by those of ordinary skill in the art that a variety of alternate and/or equivalent implementations may be substituted for the specific embodiments shown and described without departing from the scope of the present invention. For example, the present invention can be used with a variety of clock signals. The clock signals could be single-ended clock signals, or they could be combined bidirectional signals, like DQS, or they could be complimentary signals like Qk/Qk# and Dk/Dk#. This application is intended to cover any adaptations or variations of the specific embodiments discussed herein. Therefore, it is intended that this invention be limited only by the claims and the equivalents thereof.

1. A random access memory device comprising:
a controller;
a data bus coupled to the controller such that data read and data write information is transferred to and from the controller over the data bus;
multiple memory modules coupled to the data bus and to the controller, each memory module having a driver that produces an echo clock signal on an echo clock pin, the echo clock pin of each memory module being tied to each of the other memory modules and to the controller, such that during a read operation of the random access memory device the data bus and echo clock have matched loading conditions.

2. The random access memory device of claim 1 wherein each memory module further includes a buffer.

3. The random access memory device of claim 2 wherein the echo clock pin of each memory module is tied to the buffer of each of the other memory modules.

4. The random access memory device of claim 3 wherein the buffer is an unused buffer resulting from the memory module using less than it full capacity.

5. The random access memory device of claim 3 wherein the buffer is a dummy buffer added to the memory module.

6. The random access memory device of claim 2 wherein the random access memory device includes a first and a second memory module coupled to the data bus, the first memory module having a first echo clock driver producing a first echo clock signal and having a first buffer, the second memory module having a second echo clock driver producing a second echo clock signal and having a second buffer, wherein the first echo clock signal is coupled to the controller and to the second buffer and the second echo clock signal is coupled to the controller and to the first buffer such that during a read operation of the random access memory device the data bus and the first and second echo clocks have matched loading conditions.

7. The random access memory device of claim 2 wherein the random access memory device includes a first, second, third and fourth memory module coupled to the data bus, the first memory module having a first echo clock driver producing a first echo clock signal and having a first buffer, the second memory module having a second echo clock driver producing a second echo clock signal and having a second buffer, the third memory module having a third echo clock driver producing a third echo clock signal and having a third buffer, the fourth memory module having a fourth echo clock driver producing a fourth echo clock signal and having a fourth buffer, wherein the first echo clock signal is coupled to the controller and to the second, third and fourth buffers, the second echo clock signal is coupled to the controller and to the first, third and fourth buffers, the third echo clock signal is coupled to the controller and to the first, second and fourth buffers, and the fourth echo clock signal is coupled to the controller and to the first, second and third buffers such that during a read operation of the random access memory device the data bus and the first, second, third and fourth echo clocks have matched loading conditions.

8. A random access memory device comprising:
a controller;
a data bus coupled to the controller such that data read and data write information is transferred to and from the controller over the data bus;
a first memory module coupled to the data bus and to the controller, the first memory module having a driver that generates an echo clock signal and having a buffer;
a second memory module coupled to the data bus and to the controller, the second memory module having a driver that generates an echo clock signal and having a buffer, the echo clock signal of the second memory module being tied to the buffer of the first memory module and to the controller, the echo clock signal of the first memory module being tied to the buffer of the second memory module and to the controller.

9. The random access memory device of claim 8 wherein the buffers of the first and second memory modules are off and producing a load, such that during a read operation of the random access memory device the data bus and echo clock of the first memory module have matched loading conditions.

10. The random access memory device of claim 8 wherein the buffers of the first and second memory module are off and producing a load, such that during a read operation of the random access memory device the data bus and echo clock of the second memory module have matched loading conditions.

11. The random access memory device of claim 8 wherein the buffer is an unused buffer from the memory module using less than it full capacity.

12. The random access memory device of claim 8 wherein the buffer is a dummy buffer added to the memory module.

13. The random access memory device of claim 8 further including a third memory module coupled to the data bus and to the controller, the third memory module having a driver that generates an echo clock signal and having a buffer, the echo clock signal of the first memory module being tied to the buffers of the second and third memory modules and to the controller, the echo clock signal of the second memory module being tied to the buffers of the first and third memory modules and to the controller, and the echo clock signal of the third memory module being tied to the buffers of the first and second memory modules and to the controller.

14. The random access memory device of claim 13 wherein the buffers of the first, second and third memory modules are off and producing a load, such that during a read operation of the random access memory device the data bus and each echo clock have matched loading conditions.

15. The random access memory device of claim 13 further including a fourth memory module coupled to the data bus and to the controller, the fourth memory module having a driver that generates an echo clock signal and having a buffer, the echo clock signal of the first memory module being tied to the buffers of the second, third, and fourth memory modules and to the controller, the echo clock signal of the second memory module being tied to the buffers of the first, third, and fourth memory modules and to the controller, the echo clock signal of the third memory module being tied to the buffers of the first, second, and fourth memory modules and to the controller, and the echo clock signal of the fourth memory module being tied to the buffers of the first, second, and third memory modules and to the controller.

16. The random access memory device of claim 15 wherein the buffers of the first, second third and fourth memory modules are off and producing a load, such that during a read operation of the random access memory device the data bus and each echo clock have matched loading conditions.

17. A random access memory device comprising:
a controller;
a data bus coupled to the controller such that data read and data write information is transferred to and from the controller over the data bus;
multiple memory modules coupled to the data bus and to the controller, each memory module producing an echo clock signal that is received by the controller during a read operation of the random access memory device and each memory module including means for matching the loading conditions of the data bus and the memory modules.

18. The random access memory device of claim 18 wherein each memory module has a driver that produces an echo clock signal, the echo clock signal of each memory module being received by each of the other memory modules and by the controller, such that during a read operation of the random access memory device the data bus and echo clock have matched loading conditions.
